(19) United States
(12) Patent Application Publication
(10) Pub. No.: US 2014/0153182 A1
(43) Pub. Date: Jun. 5, 2014

(54) PORTABLE-COMPUTER STAND AND METHOD OF PROVIDING THE SAME

(71) Applicant: Belkin International, Inc., Playa Vista, CA (US)

(72) Inventors: Timothy North, Diamond Bar, CA (US); Kenneth Mori, Los Angeles, CA (US); Mona Lisa Alexander, San Marino, CA (US)

(73) Assignee: Belkin International, Inc., Playa Vista, CA (US)

(21) Appl. No.: 14/098,295

(22) Filed: Dec. 5, 2013

Related U.S. Application Data
(60) Provisional application No. 61/733,718, filed on Dec. 5, 2012.

(51) Int. Cl. G06F 1/16

(52) U.S. Cl. CPC G06F 1/1632; G06F 1/1633; G06F 1/1684
USPC 361/679.41; 248/176.1; 29/428; 29/825

(57) ABSTRACT

A stand for a portable computer can include a top including a front surface, a rear surface, and a trough. The stand can include a base. The rear surface can be substantially coplanar with the front surface. The rear and front surfaces can be configured to support the portable computer in a first orientation. The trough can be configured to hold the portable computer in a second orientation different from the first orientation.

### CROSS-REFERENCE TO RELATED APPLICATIONS

This application claims the benefit of U.S. Provisional Application No. 61/733,718, filed Dec. 5, 2012. U.S. Provisional Application No. 61/733,718 is incorporated herein by reference in its entirety.

### TECHNICAL FIELD

This disclosure relates generally to computer accessories, and relates more particularly to stands for portable computers.

### BACKGROUND

Portable computers are commonly used for commercial and personal purposes. Although the portable nature of such computers allows them to be used away from users' desks, users often return portable computers to their desks for storage, battery charging, and/or docking with peripheral devices, such as one or more monitors, a keyboard, a pointing device, a printer, etc. Users often want to be able to easily attach and remove a portable computer from peripheral devices at the desk. Furthermore, it is desirable for the portable computer to be able to be used and/or stored in various different configurations and orientations so as to provide the users with ready access to the screen, keyboard, and/or ports of the portable computer.

### BRIEF DESCRIPTION OF THE DRAWINGS

To facilitate further description of the embodiments, the following drawings are provided in which:

FIG. 1 illustrates a front, top, right side isometric view of a portable-computer stand, according to an embodiment;

FIG. 2 illustrates a rear, top, right side isometric view of a portable-computer stand, according to the embodiment of FIG. 1;

FIG. 3 illustrates a right side elevational view of a portable-computer stand, according to the embodiment of FIG. 1;

FIG. 4 illustrates a rear, bottom, right side isometric view of a portable-computer stand, according to the embodiment of FIG. 1;

FIG. 5 illustrates a rear, top, right side isometric view of a portable-computer stand, according to another embodiment;

FIG. 6 illustrates a front elevational view of a portable-computer stand supporting a portable computer in an angled orientation with the portable computer in a closed configuration, according to another embodiment;

FIG. 7 illustrates a front elevational view of a computer monitor and a portable-computer stand supporting a portable computer in an angled orientation with the portable computer in an open configuration, according to the embodiment of FIG. 6;

FIG. 8 illustrates a front, top, left side isometric view of a portable-computer stand supporting a portable computer in a vertical orientation with the portable computer in a closed configuration, according to another embodiment;

FIG. 9 illustrates a right side elevational view of a portable-computer stand, according to another embodiment;

FIG. 10 illustrates a front, top, right side isometric view of a portable-computer stand, according to another embodiment;

FIG. 11 illustrates a flow chart for an embodiment of a method of providing a portable-computer stand, according to the embodiment of FIG. 1.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable. “Mechanical coupling” and the like should be broadly understood and include mechanical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

Some embodiments include a stand for a portable computer. The stand includes a top. The top includes a front surface, a rear surface, and a trough. The stand includes a base. The base can be configured to be placed on a substantially horizontal surface. The rear surface is substantially coplanar with the front surface. The rear and front surfaces are configured to support the portable computer in a first orientation and in an open configuration. The trough is configured to hold the portable computer in a closed configuration and in a second orientation different from the first orientation.

Various embodiments include a method for providing a stand for a portable computer. The method includes providing a top. The top includes a front surface, a rear surface, and a trough. The method includes providing a base. The rear surface is substantially coplanar with the front surface. The rear and front surfaces are configured to support a portable computer in a first orientation. The trough is configured to hold the portable computer in a second orientation different from the first orientation.

Embodiments of a portable-computer stand can be configured to support a portable computer in multiple orientations. Embodiments of the portable-computer stand can include one or more surfaces, which can support the portable computer device in a horizontal or angled orientation. Embodiments of the portable-computer stand can include a trough, which can support the portable computer in a substantially vertical orientation.

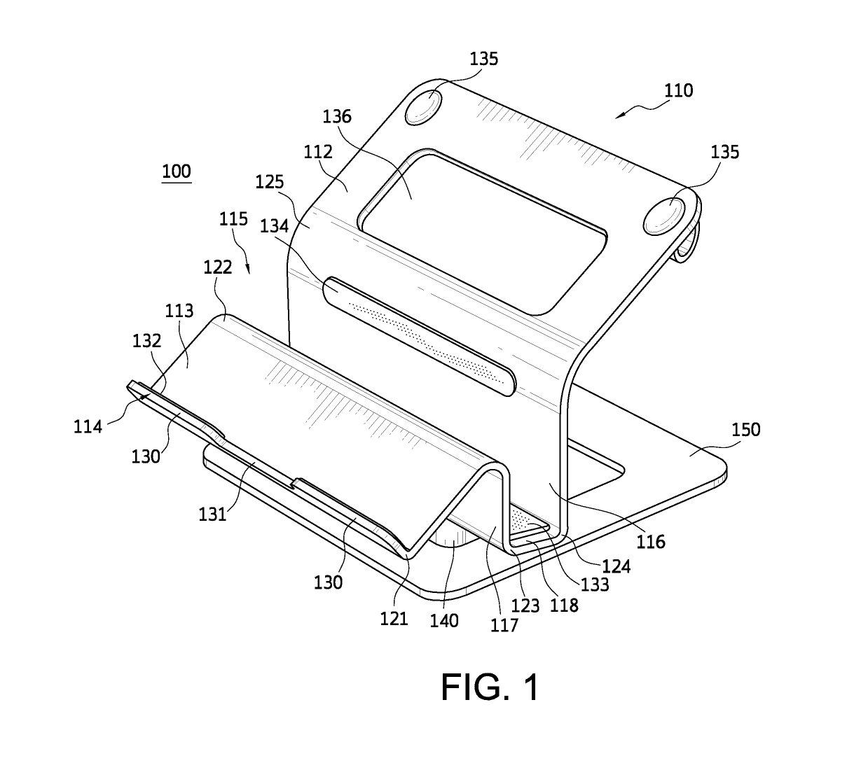

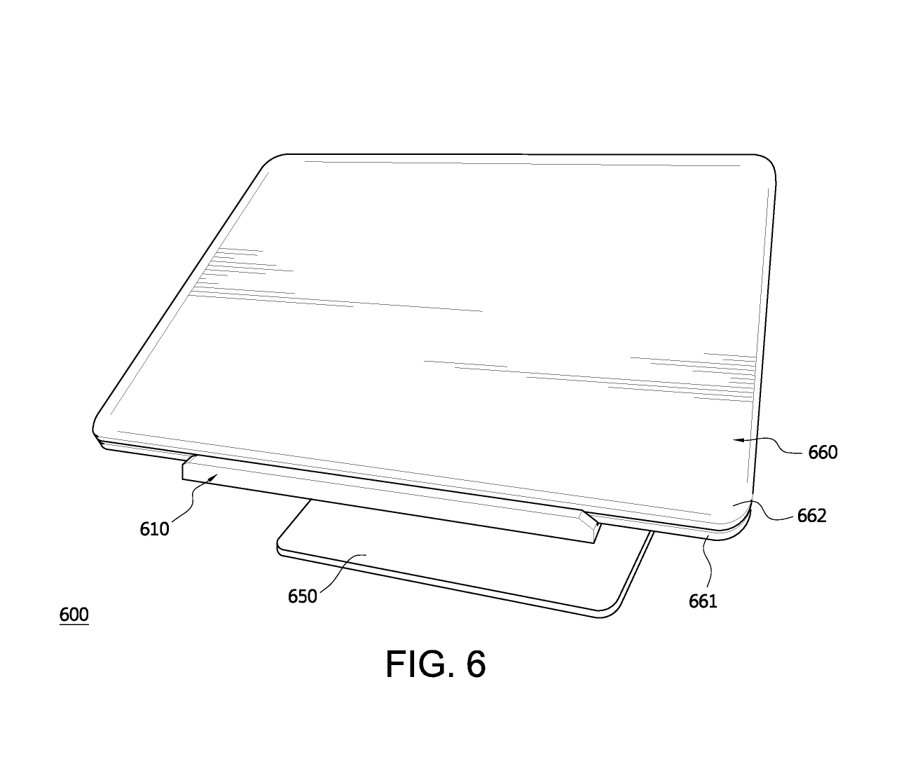

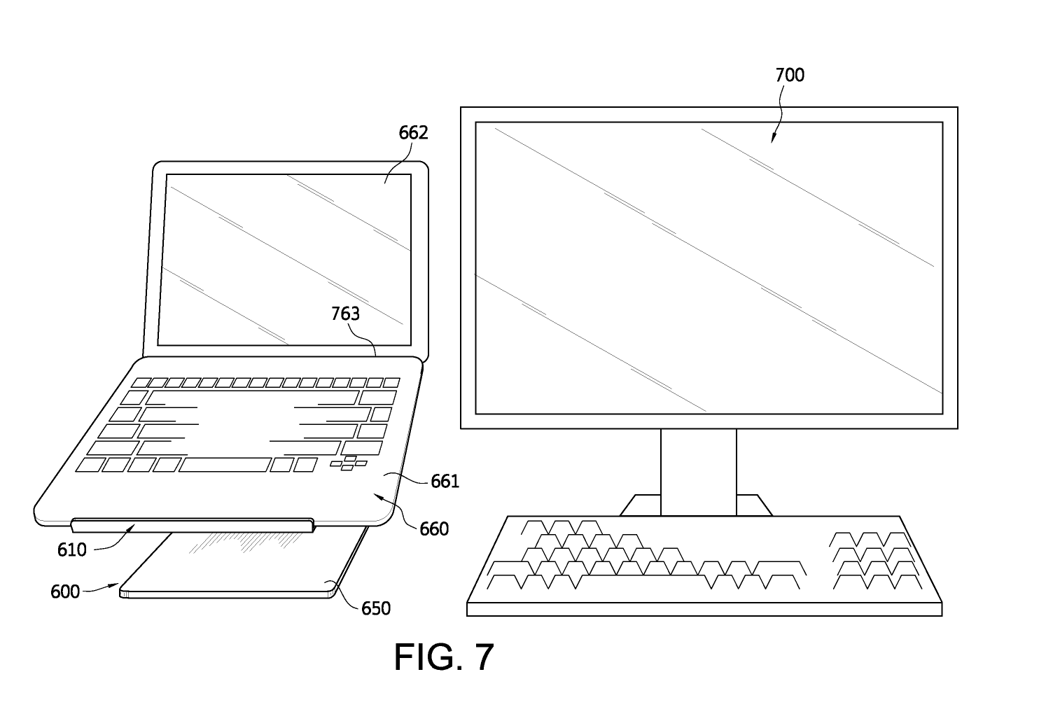

Turning to the drawings, FIG. 1 illustrates a front, top, right side isometric view of a portable-computer stand 100. Portable-computer stand 100 is merely exemplary and embodiments of the portable-computer stand are not limited to embodiments presented herein. The portable-computer stand can be employed in many different embodiments or examples not specifically depicted or described herein. Portable-computer stand 100 can include, in various embodiments, a top 110, one or more cradles 140, and a base 150. Top 110 can include a rear surface 112, a front surface 113, and/or a shelf 114. Shelf 114 can, in some embodiments, project out from a front region of front surface 113. Rear surface 112 can, in some embodiments, be coplanar with front surface 113. In various embodiments, a portable computer can be placed on rear surface 112 and front surface 113, and together rear surface 112 and front surface 113 can support the base of the portable computer. In some embodiments, when base 150 is placed on a desk or other substantially horizontal surface, front surface 113 and rear surface 112 can be substantially horizontal (not illustrated in FIG. 1) and can support the base of the portable computer in a substantially horizontal orientation (not illustrated in FIG. 1). In other embodiments, front surface 113 can be lower than rear surface 112, and together front surface 113 and rear surface 112 can support the portable computer in an angled orientation (as shown in FIGS. 6 and 7, described below). Shelf 114 can, in various embodiments, support a front side of the portable computer, such as when the portable computer is positioned in an angled orientation. Rear surface 112 and/or front surface 113 can have dimensions sufficient to support the portable computer and prevent it from tipping over and off of rear surface 112 and/or front surface 113.

Rear surface 112 can include one or more slots 136 in some embodiments.

Slots 136 can allow for increased airflow from the bottom of the portable computer and can provide for heat dissipation. Slots 136 also can reduce the amount of material used for rear surface 112 and can decrease the weight of portable-computer stand 100. Top 110 can be made of a suitable rigid polymer (e.g., polycarbonate (PC) or acrylonitrile butadiene styrene (ABS)), metal (e.g., aluminum), and/or ceramic material.

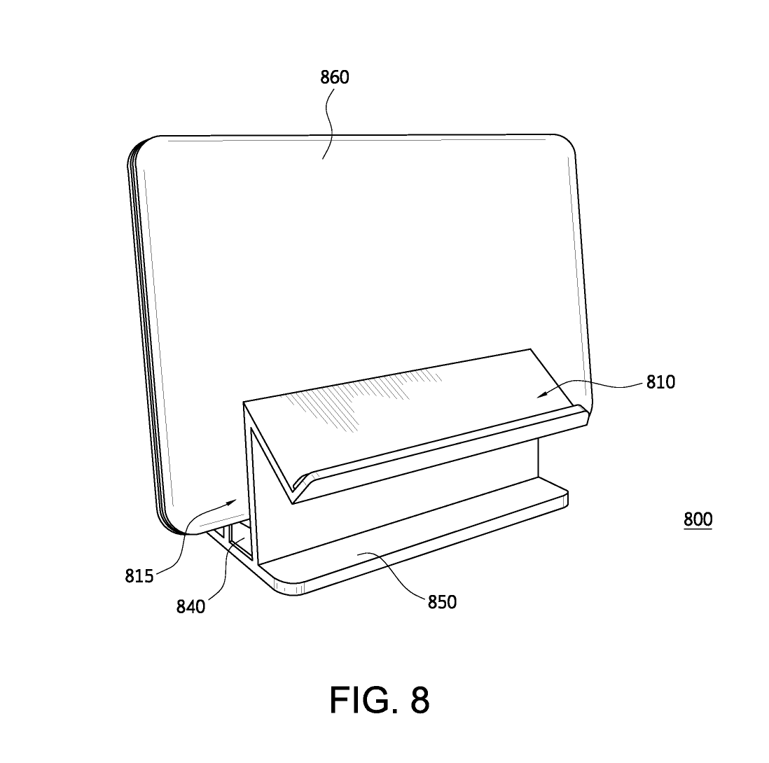

Top 110 can include a trough 115, which can support the portable computer in a substantially vertical orientation (as shown in FIG. 8, described below). Trough 115 can, in some embodiments, extend from the left side of top 110 to the right side of top 110, and can be located, in a number of embodiments, between rear surface 112 and front surface 113. Trough 115 can include a rear trough side 116, a front trough side 117, and a bottom trough side 118. In various embodiments, front trough side 117 can be substantially parallel to rear trough side 116, and can be spaced apart sufficient to allow a portable computer in a vertical orientation to fit between front trough side 117 and rear trough side 116. When the portable computer is in a vertical orientation in trough 115, bottom trough side 118 can, in some embodiments, support a side of the portable computer, and front trough side 117 and/or rear trough side 116 can provide support along the lid/screen and/or base of the portable computer to prevent the portable computer from tipping out of a vertical orientation.

In a number of embodiments, rear surface 112 can attach to rear trough side 116 at a rear interface 125. In some embodiments, front trough side 117 can connect to front surface 113 at a front interface 122. In various embodiments, bottom trough side 118 can attach to rear trough side 116 at a rear trough interface 124 and can attach to front trough side 117 at a front trough interface 123. In some embodiments, front surface 113 can attach to shelf 114 at shelf interface 121. In a number of embodiments, interfaces 121, 122, 123, 124, and/or 125 can provide an angled edge between the two interfacing surfaces. In other embodiments, interfaces 121, 122, 123, 124, and/or 125 can provide a rounded edge between the two interfacing surfaces.

In some embodiments, rear trough side 116 and front trough side 117 can be substantially vertical, and bottom trough side 118 can be substantially horizontal, forming a substantially vertical trough 115. In other embodiments, trough 115 is angled slightly rearward, such that the rear of bottom trough side 118 can be closer to base 150 than the front of bottom trough side 118, and/or the top portion of rear trough side 116 and/or front trough side 117 can be further to the rear than the bottom portion of rear trough side 116 and/or front trough side 117, respectively.

Shelf 114 can, in some embodiments, extend out a uniform distance from front surface 113. In various embodiments, shelf 114 can include shelf side regions 130 at each side of shelf 114 and a shelf center region 131 between shelf side regions 130. In some embodiments, shelf center region 131 can extend further out from front surface 113 than shelf side regions 130. In other embodiments, shelf side regions 130 can extend further out from front surface 113 than shelf center region 131.

Shelf 114 can include one or more shelf pads 132, which can be attached the upper surface of one or more of shelf side regions 130 and/or shelf center region 131. Shelf pads 132 can provide a non-slip and/or padded surface between shelf 114 and the portable computer when the portable computer is supported in an angled orientation by portable-computer stand 100. Trough 115 can include one or more trough pads 133, which can be attached to all or portions of bottom trough side 118, front trough side 117, and/or rear trough side 116. Trough pads 133 can provide a non-slip and/or padded surface between trough 115 and the portable computer when the portable computer is supported in vertical orientation by portable-computer stand 100. For example, trough pads 133 may extend partially or fully from the right side to the left side across bottom trough surface 108 and can extend up a portion of front trough side 117. Trough 115 can, in a number of embodiments, include one or more rear interface trough pads 134, which can, in various embodiments, be located at rear interface 125 and/or at the top of rear trough side 116. Rear interface trough pads 134 can provide a non-slip and/or padded surface between trough 115 and the lid/screen or base of the portable computer when the portable computer is supported in a vertical orientation by portable-computer stand 100. Rear surface 112 and/or front surface 113 can include one or more top pads 135, which can provide a non-slip and/or padded surface to rear surface 112 and/or front surface 113 between such surfaces and the base of the portable computer when the portable computer is supported in a horizontal or angled orientation by portable-computer stand 100. Pads 132, 133, 134, and/or 135 can be made of a suitable semi-rigid material, such as silicone, neoprene, rubber, or a thermoplastic elastomer (TPE) (e.g., thermoplastic polyurethane (TPU)).

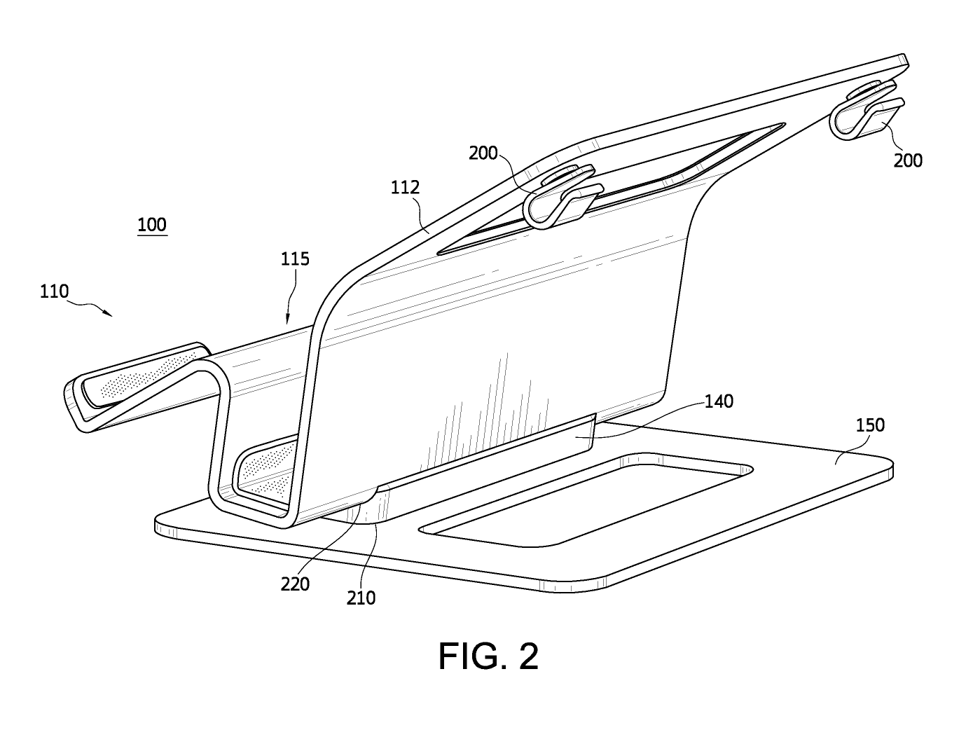

Turning ahead in the drawings, FIG. 2 illustrates a rear, top, right side isometric view of portable-computer stand 100. Rear surface 112 can include one or more clips 200. In some embodiments, clips 200 can be located at the rear edge of rear surface 112 on the lower side. Clips 200 can be used, for example, to secure and manage cables connecting to the portable computer. Clips 200 can be made of a suitable rigid polymer (e.g., PC or ABS), metal (e.g., aluminum), and/or ceramic material, and can, in some embodiments, be made of the same material as top 110.

Cradle 140 can, in some embodiments, be used to attach top 110 to base 150. In various embodiments, cradle 140 attaches to top 110 at the bottom of trough 115. Base 150 can be substantially planar and of sufficient dimensions to provide a base of support to top 110 and prevent tipping when a portable computer is placed on portable-computer stand 100 in horizontal, angled, or vertical orientations. Cradle 140 can, in some embodiments, extend partially or fully from the left side to the right side across trough 115 and/or base 150. In a number of embodiments, portable computer 100 can include more than one cradle 140, each extending partially across trough 115 and/or base 150. Cradle 140 can attach to base 150 at a bottom cradle interface 210 and can attach to top 110 at a top cradle interface 220. In a different embodiment, cradle 140 can be a part of top 110 and/or base 150.

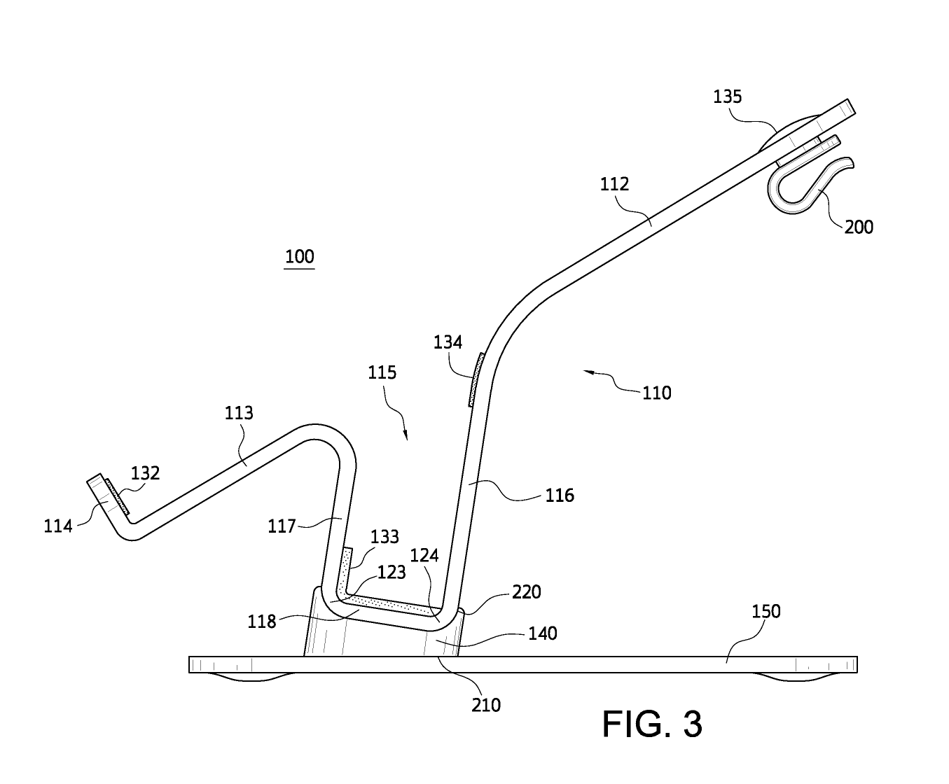

Turning ahead in the drawings, FIG. 3 illustrates a right side elevational view of portable-computer stand 100. Cradle 140 can, in various embodiments, extend from the front of trough 115 to the rear of trough 115. In a number of embodiments, for example, top cradle interface 220 can extend from front trough interface 123 to rear trough interface 124. In some embodiments, top cradle interface 220 can extend partially or fully up the outer surface of front trough side 117 from front trough interface 123 and/or up the outer surface of rear trough side 116 from back trough interface 124. Cradle 140 can be made of a suitable rigid polymer (e.g., PC or ABS), metal (e.g., aluminum), and/or ceramic material, and can, in some embodiments, be made of the same material as top 110 and/or base 150. As shown in FIG. 3, trough 115 can be angled rearward. In other embodiments, trough 115 can be vertical.

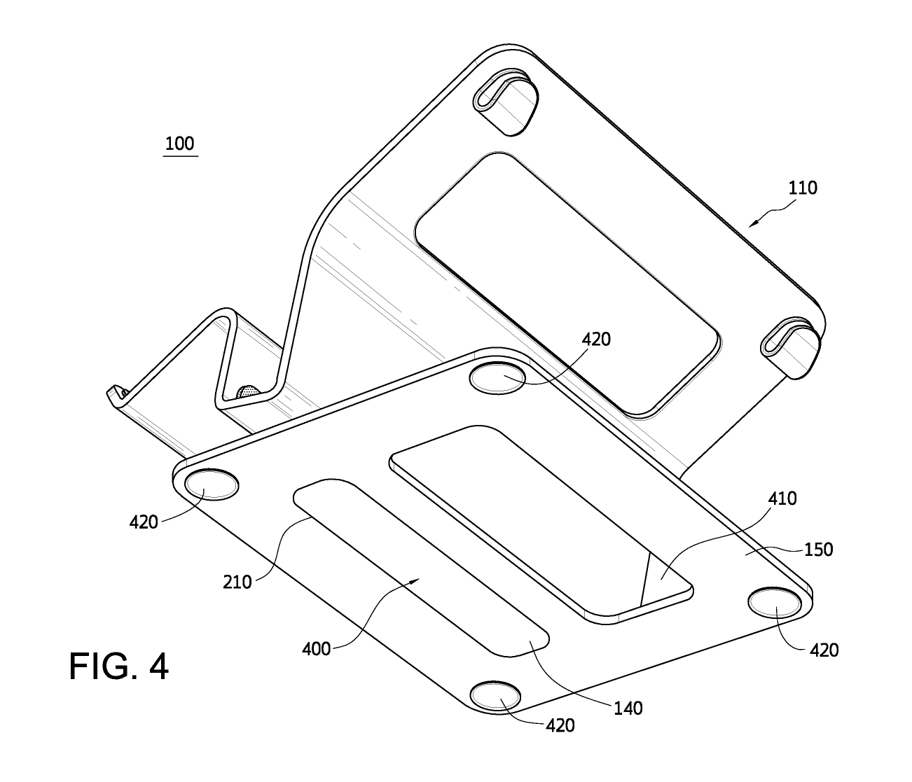

Turning ahead in the drawings, FIG. 4 illustrates a rear, bottom, right side isometric view of portable-computer stand 100. Base 150 can include one or more cradle slots 400, which can hold one or more cradles 140 at bottom cradle interface 210. Cradle slots 400 can provide additional structural support for the attachment of cradles 140 to base 150 at bottom cradle interface 210. Base 150 can include one or more base slots 410. Base slots 410 can reduce the amount of material used for base 150 and can decrease the weight of portable-computer stand 100. Base 150 can be made of a suitable rigid polymer (e.g., PC or ABS), metal (e.g., aluminum), and/or ceramic material, and can, in some embodiments, be made of the same material as top 110. Base 150 also can include one or more feet 420 located on the bottom of base 150. In some embodiments, for example, base 150 can include four feet 420, one at each corner of base 150. Feet 420 can provide a non-slip and/or padded surface between base 150 and the desk or other surface on which portable-computer stand 110 can be placed. In addition, feet 420, if adjustable, can provide additional stability for base 150 when it is placed on a slightly uneven surface. Feet 420 can be made of a suitable semi-rigid material, such as silicone, neoprene, rubber, or a TPE (e.g., TPU).

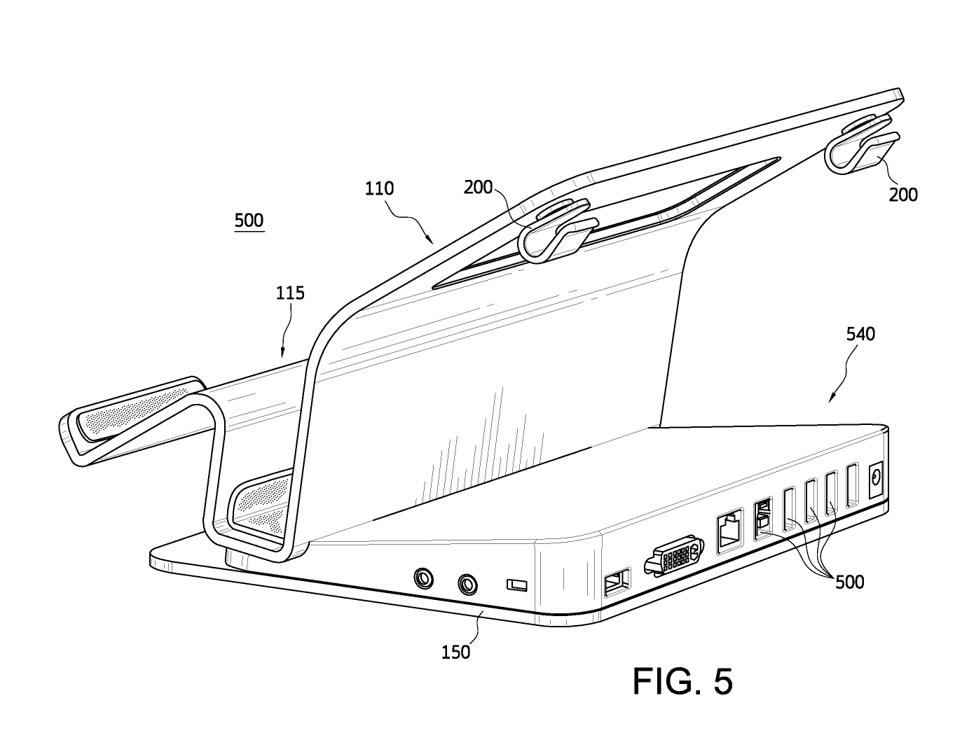

Turning ahead in the drawings, FIG. 5 illustrates a rear, top, right side view of a portable-computer stand 500. Portable-computer stand 500 can be similar to portable-computer stand 100, and various components and/or constructions of portable-computer stand 500 can be identical to various components of portable-computer stand 100. Portable-computer stand 500 can include top 110, base 150, and a docking cradle 540. Docking cradle 540 can extend from trough 115 to the rear of base 150, and/or can extend from the left side to the right side of base 150. Docking cradle 540 can attach top 110 to base 150 and can include one or more ports 500 for electrically coupling docking cradle 540 to the portable computer and/or other resources such as a power source, a computer network, peripheral devices (e.g., mouse, keyboard, printer, uniform serial bus (USB) flash drives, etc.), audio systems and/or earphones, and/or other suitable types of devices or resources. In some embodiments, ports 500 can be on at least one of the front, right, left, top, and/or rear sides of docking cradle 540. Docking cradle 540 also can include docking electronics, which can be configured, for example, to electronically couple to and/or control ports 500. Clips 200 can be used to secure and manage cables connecting to the portable computer and/or ports 500.

Turning ahead in the drawings, FIG. 6 illustrates a front elevational view of portable-computer stand 600 supporting a portable computer 660 in an angled orientation with portable computer 660 in a closed configuration. Portable-computer stand 600 can be similar to portable-computer stand 100, and various components and/or constructions of portable-computer stand 600 can be similar or identical to various components of portable-computer stand 100. Portable-computer stand 600 can include a top 610 and a base 650, and top 610 can support a portable-computer base 661 of portable computer 660. Top 610 can be similar to top 110 (FIG. 1), and base 650 can be similar to base 150 (FIG. 1). In an angled orientation, the rear portion of portable computer 660 can be supported by top 610 at a height greater than the height at which top 610 supports the front region of portable computer 660. Portable-computer stand 600 can support portable computer 660 in an open and/or closed configuration. In a closed configuration, a portable-computer lid/screen 662 of portable computer 660 can be position in close proximity to and substantially parallel to portable-computer base 661.

Turning ahead in the drawings, FIG. 7 illustrates a front elevational view of a computer monitor 700 and portable-computer stand 600 supporting portable computer 600 in an angled orientation with portable computer 660 in an open configuration. Portable computer 660 can include a hinge 763, which can be located at the rear side of portable-computer base 661 and portable-computer lid/screen 662. Hinge 763 can fold axially to allow portable-computer lid/screen 662 to be folded at various angles with respect to portable computer base 661, including a substantially vertical orientation, as shown in FIG. 7, which can allow a user to view the portable-computer screen. Portable-computer stand 600 can be placed on a surface adjacent to one or more computer monitors 700 and can provide support for portable computer 660 such that the portable-computer screen can be substantially adjacent to the screen of computer monitor 700, which can allow a user to ergonomically view both screens and/or easily switch back and forth between viewing the screens. Portable-computer base 661 can include a keyboard, which can be uncovered when portable computer 660 is supported by portable-computer stand 600 and is in an open configuration, thus allowing the user to type on the keyboard portable computer 660 and provide input directly to portable computer 660.

Turning ahead in the drawings, FIG. 8 illustrates a front, top, left side isometric view of a portable-computer stand 800 supporting a portable computer 860 in a vertical orientation with portable computer 860 in a closed configuration. Portable-computer stand 800 can be similar to portable-computer stand 100, and various components and/or constructions of portable-computer stand 800 can be similar or identical to various components of portable-computer stand 100. Portable-computer stand 800 can include a top 810, a trough 815, a cradle 840, and a base 850. Top 810 can be similar to top 110 (FIG. 1) and/or top 610 (FIG. 6); trough 815 can be similar to trough 115 (FIG. 1); cradle 840 can be similar to cradle 140 (FIG. 1) and/or cradle 540 (FIG. 5); and base 850 can be similar to base 150 (FIG. 1) and/or base 650 (FIG. 6). As shown in FIG. 8, trough 815 can be vertical. In other embodiments, trough 815 can be angled rearward. Portable computer 860 can be placed in trough 815 such that a side or edge of portable computer 860 can rest on and be supported by the bottom of the trough, and the sides of the trough can support the base and/or the lid/screen of portable computer 860 and prevent portable computer 860 from tipping out of a vertical orientation. In another embodiment, trough 815 can be used to support a tablet computing device in a portrait and/or landscape orientation. In this embodiment, trough 815 can be (but does not need to be) more shallow than the embodiment shown in FIG. 8.

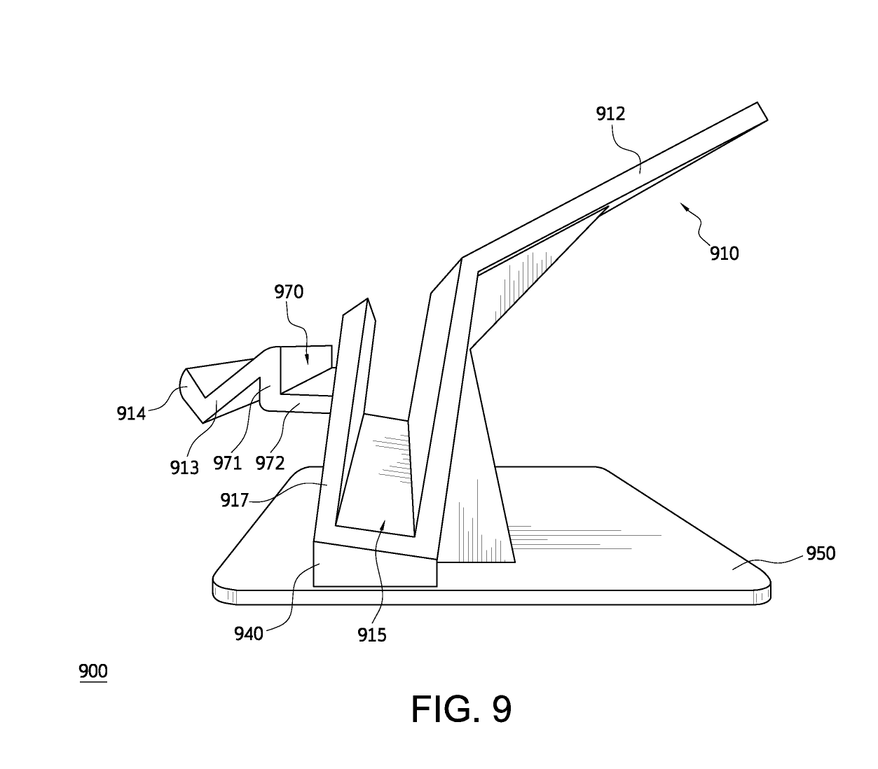

Turning ahead in the drawings, FIG. 9 illustrates a right side elevational view of a portable-computer stand 900. Portable-computer stand 900 can be similar to portable-computer stand 100, and various components and/or constructions of portable-computer stand 900 can be similar or identical to various components of portable-computer stand 100. For example, portable-computer stand 900 can include a top 910 connected to a base 950 by a cradle 940. Top 910 can be similar to top 110 (FIG. 1), top 610 (FIG. 6), and/or top 810 (FIG. 8); base 950 can be similar to base 150 (FIG. 1), base 650 (FIG. 6), and/or base 850 (FIG. 8); and cradle 940 can be similar to cradle 140 (FIG. 1), cradle 540 (FIG. 5), and/or cradle 840 (FIG. 8). Top 910 can include a rear surface 912, a front surface 913, and a trough 915. Rear surface 912 can be similar to rear surface 112 (FIG. 1); front surface 913 can be similar to front surface 113 (FIG. 1); and trough 915 can be similar to trough 115 (FIG. 1) and/or trough 815 (FIG. 8). As shown in FIG. 9, trough 915 can be angled rearward. In other embodiments, trough 915 can be vertical. In some embodiments, top 910 can include a shelf 914. Shelf 914 can be similar to shelf 114 (FIG. 1). In various embodiments, portable-computer stand 900 can include a mini-trough 970 located between trough 915 and a front surface 913. Mini-trough 970 can include a front mini-trough side 971, which can extend substantially vertically downward from front surface 913 to a bottom mini-trough side 972, which can extend substantially horizontally rearward to attach to a front trough surface 917 of trough 915. Front trough side 917 of trough 915 can be the rear side of mini-trough 917.

Mini-trough 970 can be smaller than, or the same size as, trough 915. Mini-trough 970 can be used, in some embodiments, to hold various items, such as a mobile phone or peripheral devices, for example, when the portable computer is placed in a vertical orientation in trough 915. In the same or different embodiments, mini-trough 915 can be used to hold a tablet computing device in a landscape or portrait orientation.

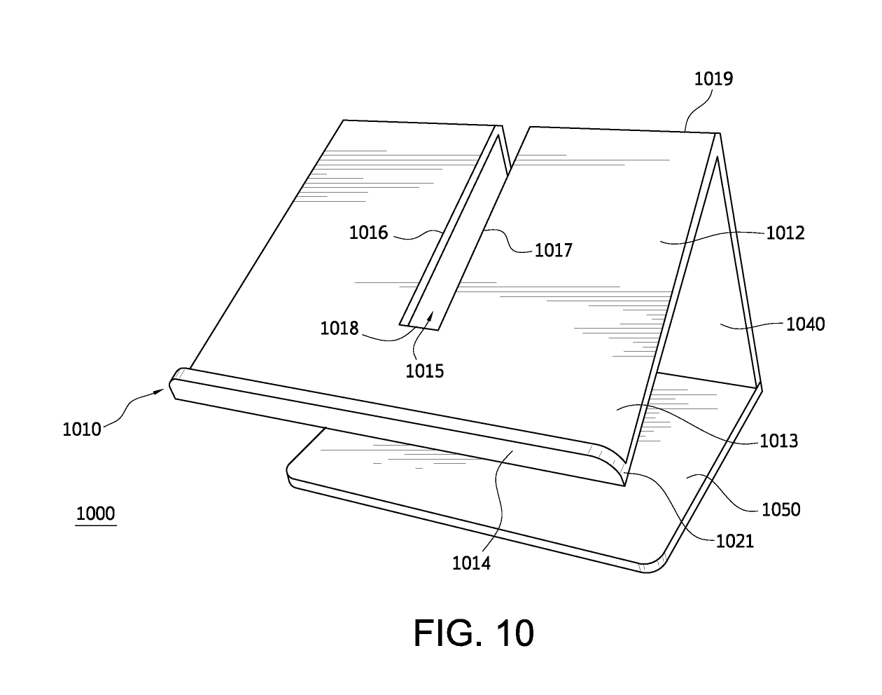

Turning ahead in the drawings, FIG. 10 illustrates a front, top, right side isometric view of a portable-computer stand 1000. In some embodiments, portable-computer stand 1000 can include a top 1010, a cradle or connector 1040, and/or a base 1050. Top 1010 can include a front surface 1013 and a rear surface 1012. Rear surface 1012 can attach to the rear portion of base 1050 via connector 1040, which can extend upward and frontward at an angle to a top edge 1019. Front surface 1013 can be coplanar and integral with rear surface 1012, which can attach to connector 1040 at top edge 1019. Front surface 1013 can extend downward and frontward at an angle to a front edge 1021, at which point a shelf 1014 can extend outward from front surface 1013. Front surface 1013 and rear surface 1012 can be planar in some embodiments. Front surface 1013, rear surface 1012, and shelf 1014 can support a portable computer in an angled orientation (as shown in FIGS. 6 and 7). Front surface 1013, rear surface 1012, and connector 1040 can include a trough 1015 extending through at least a portion of rear surface 1012 and at least a portion of connector 1040. For example, trough 1015 can extend from the middle of top edge 1019 down the center of rear surface 1012 and front surface 1013 to bottom edge 1018 on front surface 1013 and/or rear surface 1012, and trough 1015 also can extend from the middle of top edge 1019 down the center of connector 1040 (towards base 1050) to a bottom edge of connector 1040 (not shown). Bottom edge 1018 and the bottom edge of trough 1015 at connector 1040 can each be substantially horizontal, can be coplanar with each other, and can each be located approximately the same height from base 1050. Trough 1015 can include a left edge 1016 and a right edge 1017. In various embodiments, left edge 1016 can be substantially parallel to right edge 1017, and can be spaced apart sufficient to allow a portable computer in a vertical orientation to fit between left edge 1016 and right edge 1017. As shown in FIG. 10, trough 1015 can be vertical and/or can hold the portable computer in a vertical orientation. In other embodiments, trough 1015 can be angled rearward. When the portable computer is in a vertical orientation in trough 1015, the bottom edges (e.g., bottom edge 1018) can, in some embodiments, support a side of the portable computer, and left edge 1016 and/or right edge 1017 can provide support along the lid/screen and/or base of the portable computer to prevent the portable computer from tipping out of a vertical orientation.

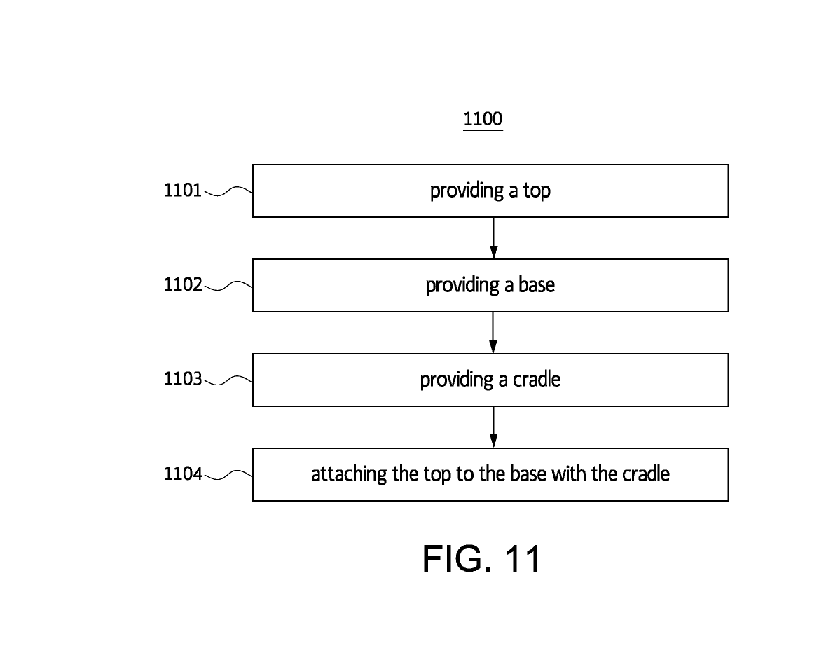

Turning ahead in the drawings, FIG. 11 illustrates a flow chart for an embodiment of method 1100 of providing a stand for a portable-computer. Method 1100 is merely exemplary and is not limited to the embodiments presented herein. Method 1100 can be employed in many different embodiments or examples not specifically depicted or described herein. In some embodiments, the procedures, the processes, and/or the activities of method 1100 can be performed in the order presented. In other embodiments, the procedures, the processes, and/or the activities of the method 1100 can be performed in any other suitable order. In still other embodiments, one or more of the procedures, the processes, and/or the activities in method 1100 can be combined or skipped.

Referring to FIG. 11, method 1100 can include procedure 1101 of providing a top. In many embodiments, the top can be similar or identical to top 110 (FIGS. 1-5), top 610 (FIGS. 6-7), top 810 (FIG. 8), top 910 (FIG. 9), and/or top 1010 (FIG. 10). In certain embodiments, the top can include a front surface, a rear surface, and a trough. The front surface can be similar or identical to front surface 113 (FIG. 1), front surface 913 (FIG. 9), and/or front surface 1013 (FIG. 10). The rear surface can be similar or identical to rear surface 112 (FIG. 1), rear surface 912 (FIG. 9), and/or rear surface 1012 (FIG. 10). The trough can be similar or identical to trough 115 (FIG. 1), trough 815 (FIG. 8), tough 915 (FIG. 9), mini-trough 970 (FIG. 9), and/or trough 1015 (FIG. 10). In a number of embodiments, the rear surface can be substantially coplanar with the front surface. In some embodiments, the rear and front surfaces are configured to support a portable computer in a first orientation. In various embodiments, the trough is configured to hold the portable computer in a second orientation different from the first orientation.

Method 1100 can continue with procedure 1102 of providing a base. In many embodiments, the base can be similar or identical to base 150 (FIGS. 1-5), base 650 (FIGS. 6-7), base 850 (FIG. 8), base 950 (FIG. 9), and/or base 1050 (FIG. 10).

Method 1100 can continue with procedure 1103 of providing a cradle. In many embodiments, the cradle can be similar or identical to cradle 140 (FIGS. 1-4), cradle 840 (FIG. 8), and/or cradle 940 (FIG. 9). In other embodiments, the cradle can be similar or identical to docking cradle 540 (FIG. 5), and can include one or more ports configured to electrically couple the portable computer to one or more peripheral devices or resources.

Method 1100 can continue with procedure 1104 of attaching the top to the base with the cradle. In some embodiments, the top can be attached to the cradle at a top cradle interface, which can be similar or identical to top cradle interface 220 (FIG. 2). In a number of embodiments, the bottom can be attached to the cradle at a bottom cradle interface, which can be similar or identical to bottom cradle interface 210 (FIG. 2).

Although the portable-computer stand has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-11 may be modified, and that the foregoing discussion of certain of these embodiments does not necessarily represent a complete description of all possible embodiments. For example, one or more of the procedures, processes, or activities of FIG. 11 may be include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A stand for a portable computer comprising:
a top comprising:
a front surface;
a rear surface; and
a trough; and
a base,
wherein:
the rear surface is substantially coplanar with the front surface;
the rear and front surfaces are configured to support the portable computer in a first orientation; and
the trough is configured to hold the portable computer in a second orientation different from the first orientation.

2. The stand of claim 1, wherein:
the trough is located between the front and rear surfaces and separates the front surface from the rear surface.

3. The stand of claim 1, wherein:
the trough extends through the rear surface.

4. The stand of claim 1, wherein:
the front and rear surfaces are angled such that the rear surface is located higher than the front surface when the base is placed on a substantially horizontal surface.

5. The stand of claim 1, wherein:
the trough is substantially vertical when the base is placed on a substantially horizontal surface.

6. The stand of claim 1, wherein:
the trough is angled rearward from vertical when the base is placed on a substantially horizontal surface.

7. The stand of claim 1 comprising:
a cradle connecting the top to the base.

8. The stand of claim 1, comprising:
a docking cradle connecting the top to the base, the docking cradle comprising one or more ports configured to electrically couple the portable computer to one or more peripheral devices or resources.

9. The stand of claim 1 comprising:
a connector connecting the top to the base.

10. The stand of claim 1, wherein:
the top comprises a shelf extending outward from the front surface.

11. The stand of claim 1 comprising:
a second trough located between the front surface and the trough.

12. The stand of claim 11, wherein:
the second trough is smaller than the trough.

13. The stand of claim 1, wherein:
the stand is configured to support the portable computer in an open configuration and a closed configuration when the portable computer is in the first orientation.

14. The stand of claim 1, wherein:
the stand is configured to support the portable computer in a closed configuration when the portable computer is in the second orientation.

15. The stand of claim 1, wherein:
the stand is not configured to support the portable computer in an open configuration when the portable computer is in the second orientation.

16. The stand of claim 1, wherein:
the front and rear surfaces are integral with each other.

17. The stand of claim 1 comprising:
a docking cradle connecting the top to the base, the docking cradle comprising one or more ports configured to electrically couple the portable computer to one or more peripheral devices or resources,
wherein:
the front and rear surfaces are angled such that the rear surface is located higher than the front surface when the base is placed on a substantially horizontal surface;
the top comprises a shelf extending outward from the front surface at an end of the front surface that is opposite the rear surface;
the trough is located between the front and rear surfaces and separates the front surface from the rear surface;
the trough is angled rearward from vertical when the base is placed on the substantially horizontal surface;
the stand is configured to support the portable computer in an open configuration and a closed configuration when the portable computer is in the first orientation; and
the stand is configured to support the portable computer in the closed configuration when the portable computer is in the second orientation.

18. The stand of claim 17 comprising:
a second trough located between the front surface and the trough.

19. The stand of claim 1 comprising:
a connector connecting the top to the base,
wherein:
the trough extends through a center of the rear surface and through a portion of a center of the front surface;
the front and rear surfaces are integral with each other;
the front and rear surfaces are angled such that the rear surface is located higher than the front surface when the base is placed on a substantially horizontal surface;
the trough is substantially vertical when the base is placed on the substantially horizontal surface;
the top comprises a shelf extending outward from the front surface at an end of the front surface that is opposite the rear surface;
the stand is configured to support the portable computer in an open configuration and a closed configuration when the portable computer is in the first orientation; and
the stand is configured to support the portable computer in the closed configuration when the portable computer is in the second orientation.

20. A method for providing a stand for a portable computer, the method comprising:
providing a top comprising a front surface, a rear surface, and a trough; and
providing a base,
wherein:
the rear surface is substantially coplanar with the front surface;
the rear and front surfaces are configured to support a portable computer in a first orientation; and
the trough is configured to hold the portable computer in a second orientation different from the first orientation.

21. The method of claim 20 comprising:
providing a cradle; and
attaching the top to the base with the cradle.

22. The method of claim 20 comprising:
providing a docking cradle comprising one or more ports configured to electrically couple the portable computer to one or more peripheral devices or resources; and
attaching the top to the base with the docking cradle.
